(19) United States
(12) Patent Application Publication
(10) Pub. No.: US 2005/0073932 A1
(43) Pub. Date: Apr. 7, 2005

(54) Optical disc apparatus

(76) Inventors: Tetsuya Shihara, Kadoma-shi Osaka (JP); Yoshihiro Kanda, Toyono-gun (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(21) Appl. No.: 10/498,909

(22) PCT Filed: Dec. 24, 2002
(86) PCT No.: PCT/JP02/13468

(30) Foreign Application Priority Data
Dec. 26, 2001 (JP) 2001-393422

(51) Int. Cl. G11B 5/09

(52) U.S. Cl. 369/59.21; 369/59.19; 369/59.16; 369/59.14

(57) ABSTRACT

An optical disc drive reads and/or writes data from/on an optical disc with sectors, each including a header area, having two or more identical marks or pits with a predetermined length, and a user data area. The drive includes: an optical head, which emits light toward the disc and receives the reflected light, thereby outputting a signal; read means for generating an RF read signal from the output of the head; digitizing means for generating a digitized read signal from the RF read signal; clock generating means for generating a clock signal; a phase control section and a frequency control section for controlling the clock generating means such that the phase or frequency of channel clock pulses of the digitized read signal matches with that of the clock signal; first information detecting means for detecting information represented by the marks or pits from the digitized read signal; and control switching means for instructing the frequency control section to stop controlling the clock generating means based on detection results of the first information detecting means.

### TECHNICAL FIELD

The present invention relates to an optical disc drive for reading or writing data from/on an information storage medium optically by using a light beam, and also relates to a method for controlling the optical disc drive.

### BACKGROUND ART

An optical disc drive for reading and/or writing data from/on an information storage medium such as an optical disc usually includes rotation control means for rotating the information storage medium at a predetermined rotational velocity, focus control means for converging a light beam to be radiated toward the information storage medium into a predetermined focusing state, and tracking control means for making the light beam scan the target tracks on the information storage medium just as intended.

FIG. 1 is a block diagram showing an exemplary conventional optical disc drive. In the conventional optical disc drive, an optical head 2 radiates a focused laser beam onto an optical disc 1 and receives the light reflected from the optical disc. A preamplifier 3 generates an RF read signal and a servo signal from the output of the optical head 2. A focus control section 8 controls the focusing state of the laser beam into a predetermined state. A tracking control section 7 controls the light beam such that the light beam can scan information tracks. The focus control section 8 and tracking control section 7 are normally combined together as a controller 9 for performing its control operations through digital signal processing. Performing the focus and tracking control operations, the optical disc drive reads or writes data from/on the optical disc.

Examples of information storage media to be processed by the optical disc drive include a disc on which data is written using a sector, consisting of a header area and a data area, as a unit block (e.g., a DVD-RAM (digital versatile disc-random access memory) disc). FIG. 2 shows an exemplary sector of such an information storage medium. As shown in FIG. 2, each sector includes a header area 308 and a data area 309. The header area 308 includes an AS 300, on which information indicating the beginning of the header area is stored, and an AE 304, on which information indicating the end of the header area 308 is stored, at the beginning and at the end thereof, respectively. The range sandwiched between the AS 300 and the AE 304 is divided into a first half and a second half. The first half includes a VFO 301 on which a single pattern is stored, an AM 302 indicating that address information has already been written, and an ID 303 on which the address information is stored, in this order in the direction in which the light beam scans. The second half also includes a VFO 301′, an AM 302′ and an ID 303′ on which the same types of information as those of the first half are stored. The data area 309 includes a VFO 301″ on which the same data as the VFO 301 is written, a DS 305 indicating that user data has already been written, a DATA 306 on which the user data is written, and a DE 307 indicating the end of the data area 309.

The VFOs 301 and 301′ are either pits or marks having a predetermined length and provided on concave or convex portions. Each VFO represents a single type of information by the length of the pits or marks. In accordance with the information stored on the VFOs 301 and 301′, the optical disc drive generates a sync clock signal and adjusts subsequent information read or write timings in response to the sync clock signal generated.

The upper portion of FIG. 3 schematically illustrates the structures of the header and data areas on an optical disc. Data areas 400 and 402 are arranged on the centerline of a track A, while data areas 401 and 403 are arranged on the centerline of another track B adjacent to the track A. On the other hand, pits 405 and 405′ representing the information stored on the header area are arranged so as to have an offset equivalent to a half track pitch with respect to the track A. As shown in FIG. 3, the pit 405 representing the information about the first half of the header area may be located under the track A with an offset, while the pit 405′ representing the information about the second half of the header area may be located over the track A with an offset. In the header area, mirror-polished mirror portions 404 and 404′ are further provided elsewhere in addition to the pits.

The lower portion of FIG. 3 shows the intensity of an RF read signal 406 obtained by scanning the track A. As shown in FIG. 3, the mirror portion 404 or 404′ is located on one side of the center of the track A in the header area, and therefore, the quantity of light reflected from the optical disc increases there. Accordingly, the RF read signal obtained from the header area has a higher intensity than the RF read signal obtained from the data area, and is offset as a whole.

In passing the RF read signal through a high-pass filter (HPF) to digitize such a read signal, the cutoff frequency of the HPF is increased in a short time at the beginning of the header area, thereby absorbing the DC (direct current) level of the read signal obtained from the header area and matching the DC level of the header area with that of the data area. This processing is called “inline processing”. FIG. 4 shows an exemplary inline circuit used for this purpose. The inline circuit 4 includes a capacitor 501 and a resistor 502 that together makes up an HPF 500 and a SHORT switch 503 for changing the cutoff frequency of the HPF. When the SHORT switch 503 is turned ON, DC components can be absorbed. Generally speaking, a switch made up of transistors has an ON-state resistance when closed. Accordingly, the cutoff frequency of the SHORT switch 503 is finite.

An offset detector circuit 30 is provided so as to receive the read signal from the inline circuit 4 and detect the intensity of the read signal. As described above, the read signal obtained from the header area is offset with respect to the read signal obtained from the data area. The offset detector circuit 30 detects the rise of the offset portion of the read signal and outputs a SHORT signal to the SHORT switch 503 to turn the SHORT switch 503 ON.

FIG. 5 schematically shows the read signals at respective components of the optical disc drive. An RF read signal 600 includes data areas 606 and 606′ and a VFO 603 and an ID 604 making up a header area. The signals representing the VFO 603 and ID 604 are offset. The optical disc drive detects the magnitude of the RF read signal 600 and detects the VFO 603 from the header area. Then, the offset detector circuit 30 outputs a SHORT signal 601. As a result, the SHORT switch 503 shown in FIG. 4 is turned ON and the cutoff frequency of the HPF 500 increases.

Consequently, the DC level of the VFO portion 603 of the RF read signal 602 being passed through the HPF and that of the ID portion 604 on which the address information is stored are shifted to a reference voltage (i.e., the SHORT voltage) as shown in FIG. 5. The SHORT signal 601 is optimized so as to be output for a period of time that is long enough to perform the inline processing. Thereafter, even when the SHORT signal 601 is no longer output, the RF read signal 600 obtained from the header area is still in the inline state because the DC level is absorbed.

As shown in FIG. 1, the signal that has been subjected to the inline processing in this manner has its waveform equalized by the waveform equalizer circuit 5 and then input to the digitizer circuit 10. The slice level of the digitizer circuit 10 is generated by a slice level control circuit, which follows the average level of the read signal. Then, the digitized read signal is input to the frequency control section 16 and the phase control section 15. The frequency control section 16 extracts a signal, having a long period and included in advance in the read signal, thereby detecting the frequency of the read signal. If the detected frequency is higher than the desired frequency, then the frequency control section 16 outputs a negative pulse. On the other hand, if the detected frequency is lower than the desired frequency, then the frequency control section 16 outputs a positive pulse. This positive or negative pulse is passed to a low pass filter (LPF) 14, averaged there, and then subjected to a voltage transformation. In accordance with this voltage, the clock generator section 12 generates a sync clock signal for reading the information to be read.

Meanwhile, the phase control section 15 compares the phase of the digitized data with that of the sync clock signal that has been generated by the clock generator section 12. When finding the former phase ahead of the latter phase, the phase control section 15 outputs a positive pulse. On the other hand, on finding the former phase trailing behind the latter phase, the phase control section 15 outputs a negative pulse. Just like the output of the frequency control section, this positive or negative pulse is passed to the LPF 14 and then subjected to a voltage transformation. In this manner, a sync clock signal, synchronized with (i.e., in phase with) the read signal, is generated by the frequency control section 16 and phase control section 15. By inputting this sync clock signal and digitized signal to a decoder circuit 13 and latching the read data and read signal in response to the sync clock signal, digital data is demodulated.

In such an optical disc drive performing frequency and phase control operations, the output stage of the frequency control section 16 has a relatively large gain to generate the sync clock signal quickly within a phase controllable range. Accordingly, if the output of the frequency control section 16 were input to the LPF 14, then that signal would provoke disturbance in the phase control section 15, thus possibly increasing the jitter of the read signal.

To avoid these inconveniences, the sync clock signal is preferably generated only by the phase control when the address information and the user data are read out from the header area and data area, respectively, as disclosed in Japanese Laid-Open Publication No. 2000-285605. For that purpose, in the optical disc drive shown in FIG. 1, the offset detector circuit 30 detects the rise of the offset portion of the read signal and the control switching section 20 prevents the frequency control section 16 from operating (see FIG. 5). This is because the rise of the offset portion in the read signal represents the beginning of the VFO portion in the header area.

Such a conventional optical disc drive, however, detects the beginning of the VFO portion by the variation in the intensity of the signal. Accordingly, if some scratch has been done on a given optical disc or if the tracking control has lost its stability to a certain degree, then the read signal could have some intensity variation and the offset detector circuit 30 might sense the intensity variation by mistake. In that case, the frequency control section 16 could be inactivated when the frequency control should not be stopped and the read signal could not be synchronized as intended.

Also, the signal level of the read signal obtained from the header area does not always have a constant offset with respect to that of the read signal obtained from the data area. The signal amplitude, represented by the length of marks or pits in the read signal, is changeable due to intersymbol interference, for example. Accordingly, if the offset level of the header area has deviated from the threshold value for detecting the offset, then the header area could not be detected. In that case, the frequency control section could not be inactivated and the signals, representing the address information in the header area and information in the user area, would have deteriorated quality.

### DISCLOSURE OF INVENTION

In order to overcome the problems described above, the present invention provides an optical disc drive, which can detect information about a given optical disc accurately and which can read the information from the optical disc only by the phase control, and a method for controlling such an optical disc drive.

An optical disc drive according to the present invention reads and/or writes data from/on an optical disc with a plurality of sectors, each including a header area, in which at least two identical marks or pits are arranged so as to have a predetermined length apiece, and a data area to store user information thereon. The optical disc drive includes: an optical head, which emits light toward the optical disc and receives the light reflected from the optical disc, thereby outputting a signal; read means for generating an RF read signal from the output signal of the optical head; digitizing means for generating a digitized read signal from the RF read signal; clock generating means for generating a clock signal; a phase control section for controlling the clock generating means such that the phase of channel clock pulses of the digitized read signal matches with that of the clock signal; a frequency control section for controlling the clock generating means such that the frequency of the channel clock pulses of the digitized read signal matches with that of the clock signal; first information detecting means for detecting information represented by the marks or pits from the digitized read signal; and control switching means for instructing the frequency control section to stop controlling the clock generating means based on detection results obtained by the first information detecting means.

In one preferred embodiment, the optical disc drive further includes second information detecting means for detecting information, which changes in a period of the same length as the information represented by marks or pits that are twice as long as the predetermined length, from the digital read signal. The control switching means instructs the frequency control section to stop controlling the clock generating means based on detection results obtained by either the first information detecting means or the second information detecting means.

In another preferred embodiment, the optical disc drive further includes third information detecting means for detecting information, which changes in a period that is an integral number of times as long as one period of the marks or the pits, from the digitized read signal. The control switching means instructs the frequency control section to stop controlling the clock generating means based on detection results obtained by either the first information detecting means or the second information detecting means.

In another preferred embodiment, the information is binary data. Also, the marks or the pits make up a VFO section to be provided for the header area.

In another preferred embodiment, the optical disc drive further includes slice level control means for controlling a slice level at which the digitizing means generates the digitized read signal from the RF read signal. If the first, second or third information detecting means has failed to detect the information in a predetermined number or more, then the slice level is changed. But if the first, second or third information detecting means has successfully detected the information in at least the predetermined number, then the control switching means instructs the frequency control section not to control the clock generating means anymore.

In another preferred embodiment, the optical disc drive further includes: waveform equalizing means for amplifying the RF read signal with such a gain characteristic as increasing an amplification factor in a higher frequency range; and gain characteristic control means for controlling the gain characteristic. If the first, second or third information detecting means has failed to detect the information in a predetermined number or more, then the gain characteristic is changed. But if the first, second or third information detecting means has successfully detected the information in at least the predetermined number, then the control switching means instructs the frequency control section not to control the clock generating means anymore.

An optical disc drive controlling method according to the present invention is a method for controlling an optical disc drive, which reads and/or writes data from/on an optical disc with a plurality of sectors, each including a header area, in which at least two identical marks or pits are arranged so as to have a predetermined length apiece, and a data area to store user information thereon. The method includes the steps of: (A) generating a digitized read signal from light that has been emitted toward, and reflected from, the optical disc; (B) generating a clock signal and controlling the phase and frequency of the clock signal such that the phase and frequency of the clock signal match with those of channel clock pulses of the digitized read signal; and (C1) stopping controlling the frequency of the clock signal as soon as information represented by the marks or pits is detected from the digitized read signal.

In one preferred embodiment, the method further includes the step (C2) of stopping controlling the frequency of the clock signal as soon as information, which changes in a period of the same length as the information represented by marks or pits that are twice as long as the predetermined length, is detected from the digitized read signal.

In another preferred embodiment, the method further includes the step (C3) of stopping controlling the frequency of the clock signal as soon as information, represented by marks or pits of which the period is an integral number of times as long as one period of the marks or the pits, is detected from the digitized read signal.

In another preferred embodiment, the information is binary data. Also, the marks or the pits make up a VFO section.

In another preferred embodiment, the step (A) includes the steps of: (a1) generating an RF read signal from the reflected light; and (a2) generating the digitized read signal from the RF read signal according to a predetermined slice level. The method further includes the step (D1) of changing the slice level for use in the step (a3) if the information has not been detected in a predetermined number or more in the step (C1), (C2) or (C3), but stopping controlling the frequency of the clock signal if the first, second or third information detecting means has successfully detected the information in at least the predetermined number.

In another preferred embodiment, the step (A) includes the steps of: (a1) generating an RF read signal from the reflected light; (a3) amplifying the RF read signal with such a gain characteristic as increasing an amplification factor in a higher frequency range; and (a4) generating the digitized read signal from the amplified RF read signal according to a predetermined slice level. The method further includes the step (D2) of changing the gain characteristic for use in the step (a3) if the information has not been detected in a predetermined number or more in the step (C1), (C2) or (C3), but stopping controlling the frequency of the clock signal if the first, second or third information detecting means has successfully detected the information in at least the predetermined number.

In another preferred embodiment, if no address information is detectable from the digitized read signal anymore when control of the frequency of the clock signal is stopped in the step (C1), (C2), (C3), (D1) or (D2), then the step (B) and one of the steps (C1), (C2) and (C3) are performed.

A computer readable storage medium according to the present invention has stored thereon a program that is defined so as to make a computer execute the respective steps of one of the methods described above.

### BRIEF DESCRIPTION OF DRAWINGS

FIG. 1 is a block diagram showing a configuration for a conventional optical disc drive.

FIG. 2 is a schematic representation showing a format for information to be written or stored on an optical disc.

FIG. 3 is a schematic representation showing the structure of a portion of the information storage layer of an optical disc.

FIG. 4 is a circuit diagram showing an exemplary inline circuit.

FIG. 5 is a time chart showing read signals output from a preamplifier and the inline circuit.

FIG. 6 is a block diagram showing an optical disc drive according to a first preferred embodiment of the present invention.

FIG. 7 is a block diagram showing a configuration for an information detecting section.

FIG. 8 is a schematic representation showing how a pattern comparing section makes the comparison.

FIG. 9 is a block diagram showing an optical disc drive according to a second preferred embodiment of the present invention.

FIG. 10 shows pits generating a single signal in a VFO section and a read signal and a digitized signal obtained from those pits.

FIG. 11 is a schematic representation showing how a pattern comparing section makes the comparison.

FIG. 12 is a block diagram showing an optical disc drive according to a third preferred embodiment of the present invention.

FIG. 13 is a flowchart showing a procedure to correct the slice level.

FIG. 14 is a block diagram showing an optical disc drive according to a fourth preferred embodiment of the present invention.

FIG. 15 shows the gain characteristics of a waveform equalizer circuit.

FIG. 16 shows relationships between read signals with different amplitudes and their digitized read signals.

FIG. 17 is a flowchart showing a procedure to correct the gain characteristic.

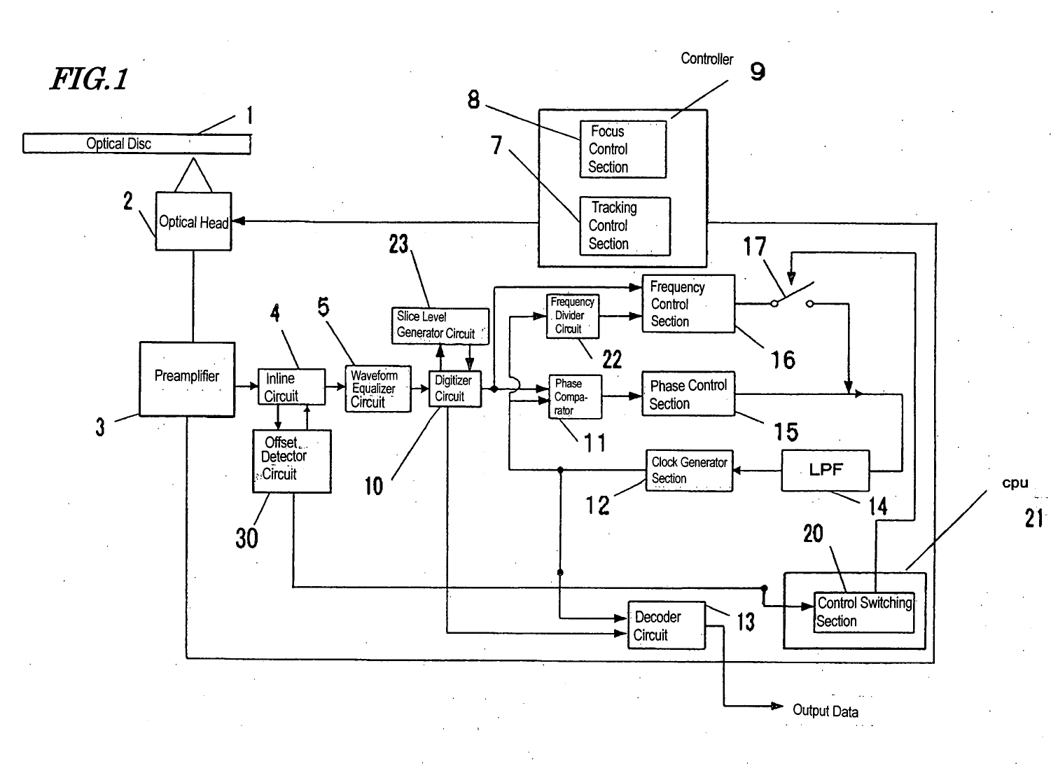

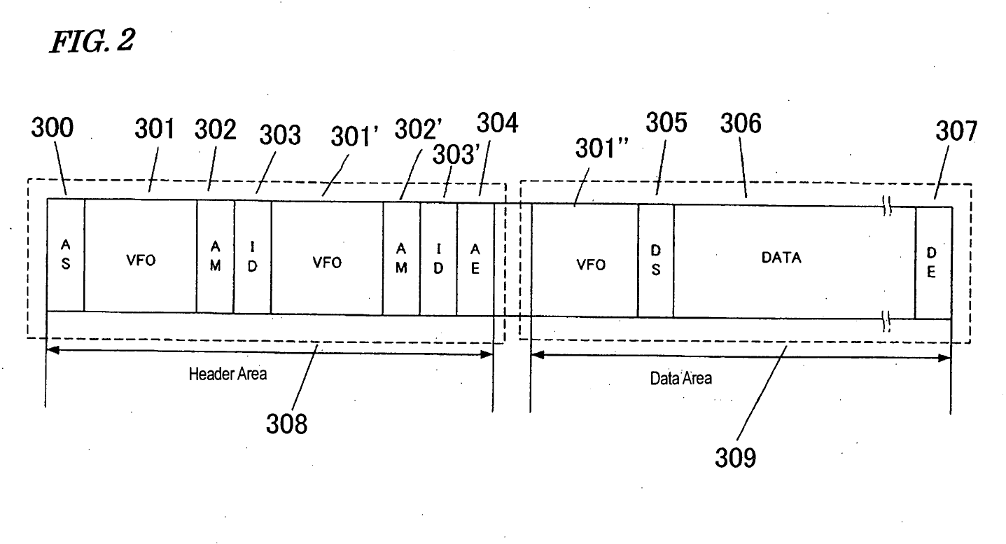

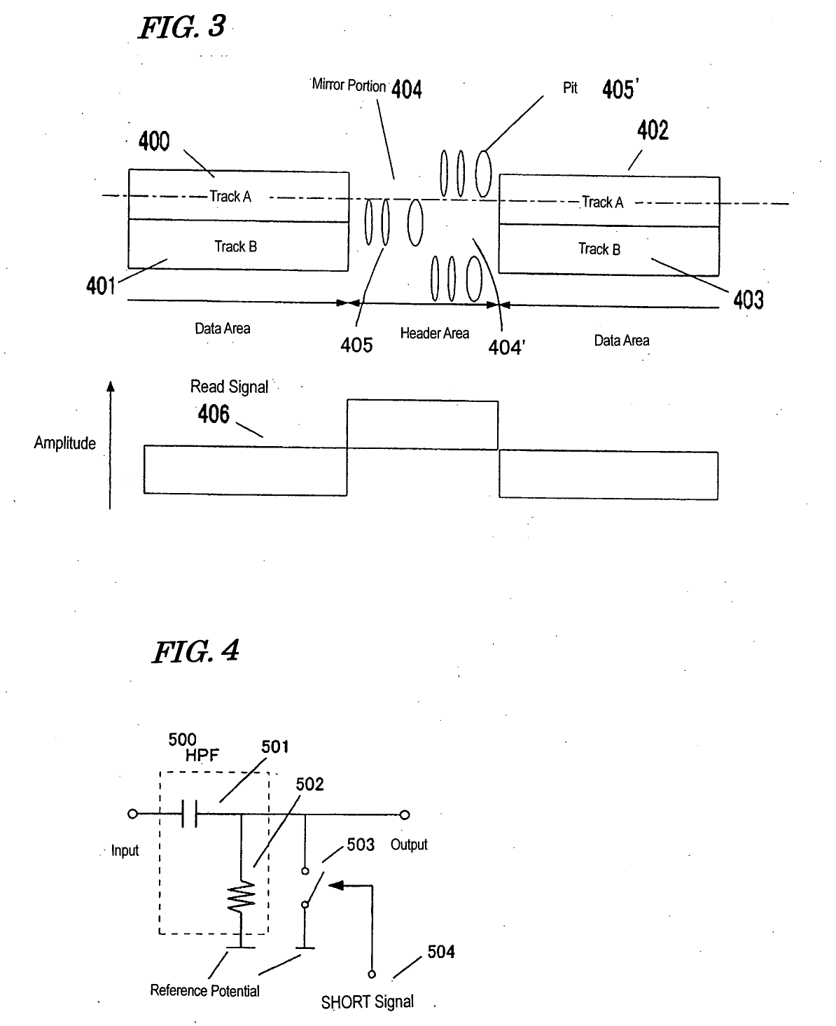

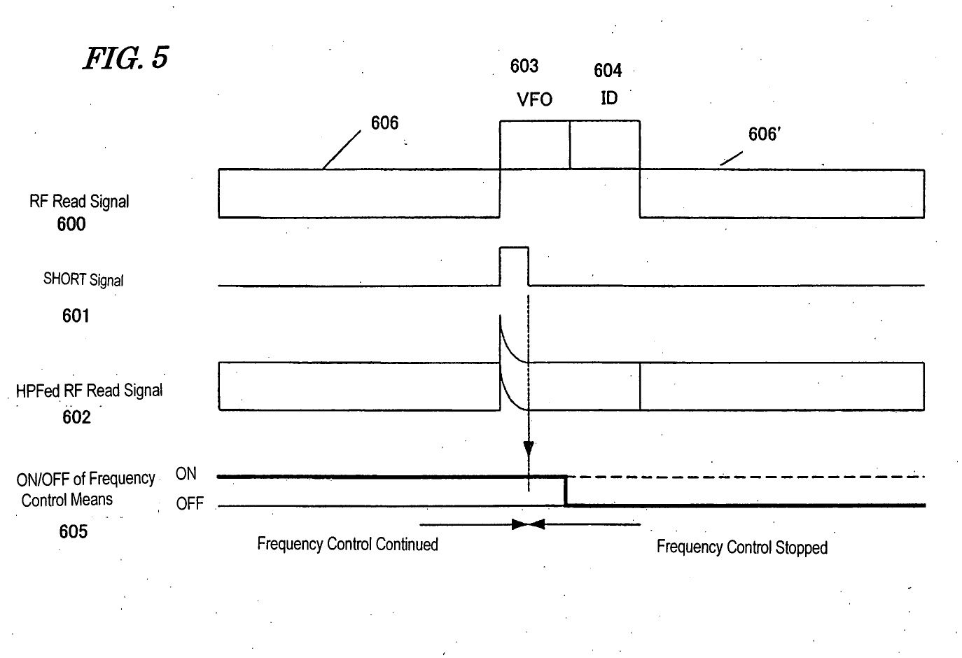

### BEST MODE FOR CARRYING OUT THE INVENTION

Embodiment 1

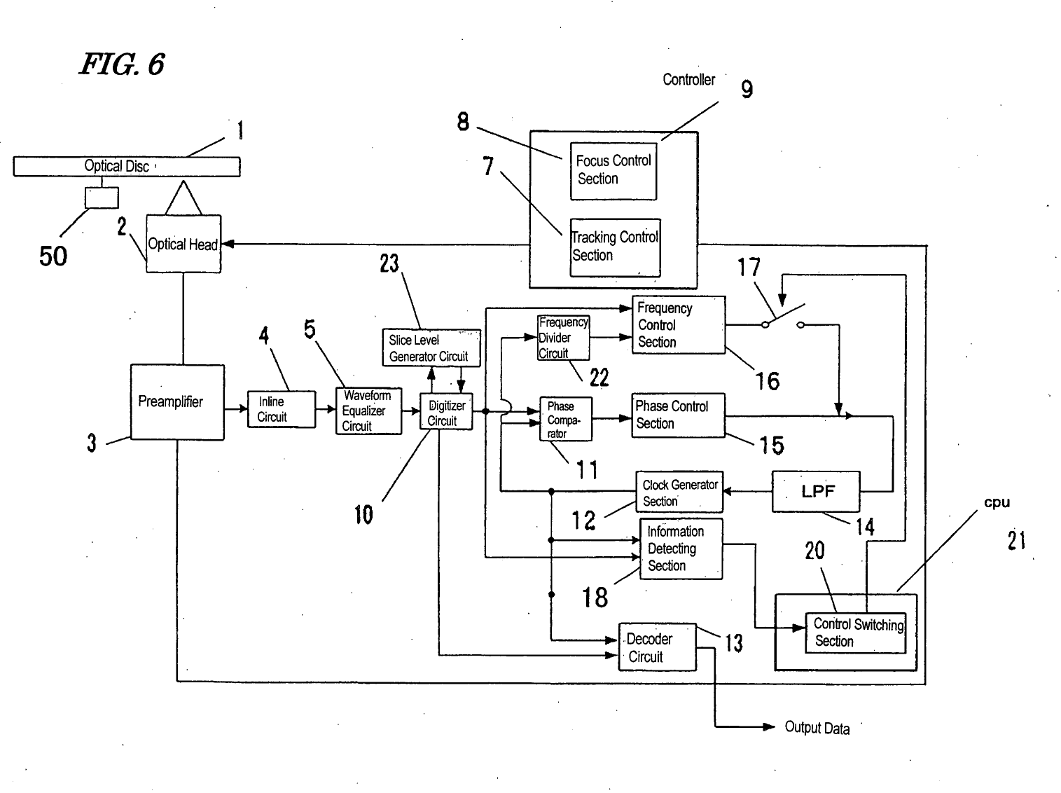

FIG. 6 is a block diagram showing an optical disc drive according to a first preferred embodiment of the present invention.

The optical disc drive shown in FIG. 6 includes a rotating means 50 such as a motor for rotating an optical disc 1 as an information storage medium, an optical head 2 for radiating a focused light beam toward the optical disc 1 and receiving the reflected light, a preamplifier 3 equivalent to read means, a tracking control section 7 for scanning a target track, and a focus control section 8 for controlling the focusing state of the light beam such that the light beam always maintains a predetermined state. The preamplifier 3 receives the output of the optical head 2, representing the reflected light, thereby generating an RF read signal and a servo signal.

The RF read signal is input to an inline circuit 4 for performing inline processing on a signal obtained from a header area. As a result, the amplitude of the signal obtained from the header area and that of a signal obtained from a data area can have their center levels matched with each other. The output of the inline circuit 4 is supplied to a waveform equalizer circuit 5. The read signal with the equalized waveform is then digitized by a digitizer circuit 10 so as to be a digitized read signal with a pulsed waveform.

The optical disc drive further includes a clock generator section 12 for generating a sync clock signal and a phase comparator 11 for comparing the phases of the sync clock signal and digitized read signal with each other. A phase control section 15 generates a phase error signal in accordance with the output of the phase comparator 11. The phase error signal is input as a control voltage to the clock generator section 12 by way of a low pass filter (LPF) 14.

The digitized read signal is also input to a frequency control section 16. Meanwhile, the sync clock signal, generated by the clock generator section 12, has its frequency divided by a frequency divider circuit 22. The frequency control section 16 compares the divided frequency of the clock signal, generated by the frequency divider circuit 22, with the frequency of a portion of the digitized read signal with a relatively long period, thereby detecting a frequency error. The detection result is input as a control signal to the clock generator section 12 by way of the LPF 14. The outputs of the phase control section 15 and frequency control section 16 may be either charge pump currents or pulse voltage outputs or have any other form as long as the LPF 14 can convert it into information that controls the clock generator section 12.

A clock signal synchronized with the digitized read signal is generated by using such a configuration. Then, a decoder 13 demodulates digital data from the sync clock signal and the digitized read signal. The output of the decoder 13 is transmitted to an error corrector circuit (not shown) and then becomes read data of the optical disc drive.

Hereinafter, it will be described in detail how the optical disc drive performs its control operation using the frequency control section 16 and phase control section 15.

In loading the optical disc 1 into the optical disc drive to read information from the optical disc 1, a sync clock signal, synchronized with the read signal, is generated, and phase control and frequency control are carried out at the same time to demodulate digital data using the sync clock signal generated. For that purpose, the optical disc drive includes a control switching section 20, and controls the control switching section 20, thereby turning the switch 170N and supplying the output of the frequency control section 16 to the clock generator section 12 by way of the LPF 14. The output of the clock generator section 12 is supplied to the frequency control section 16 by way of the frequency divider circuit 22. The digitized read signal is also input to the frequency control section 16. In this manner, a frequency control loop is established.

On the other hand, the digitized read signal is also input to the phase comparator 11 and a phase control loop is made up of the phase comparator 11, phase control section 15, LPF 14 and clock generator section 12. By using these loops, the phase control and frequency control can be performed in parallel such that the frequency and phase of the clock signal, output from the clock generator section 12, are matched with those of the digitized read signal. As a result, proper read data can be obtained from the digitized read signal.

When the sync clock signal and digitized read signal can have their phases and frequencies matched with each other as described above, the frequency control is stopped and the sync clock signal is generated with only the phase control continued. For that purpose, the optical disc drive of this preferred embodiment includes an information detecting section 18, which detects the information represented by pits or marks in the VFO portion of a header area on the optical disc. On detecting the information representing the VFO portion in the read signal, the information detecting section 18 outputs a control signal to the control switching section 21, thereby cutting off the frequency control loop and allowing only the phase control by the phase control section 16.

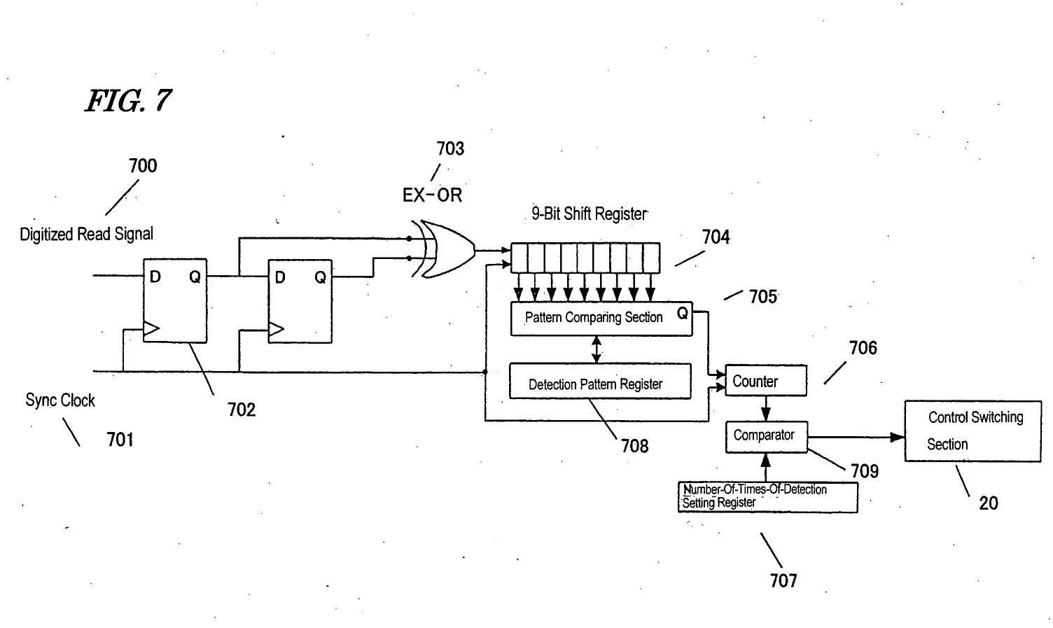

FIG. 7 shows an exemplary configuration for the information detecting section 18. In the information detecting section 18, the digitized read signal 700 is stored as binary data in a shift register 704 by using D flip-flop circuits 702 and an exclusive-OR circuit (EX-OR) 703. On the other hand, the VFO detection pattern in binary data to be detected is stored beforehand in a detection pattern register 708. At a latching timing as defined by the sync clock signal 701, a pattern comparing section 705 compares the detection pattern with the digital information stored in the shift register 704.

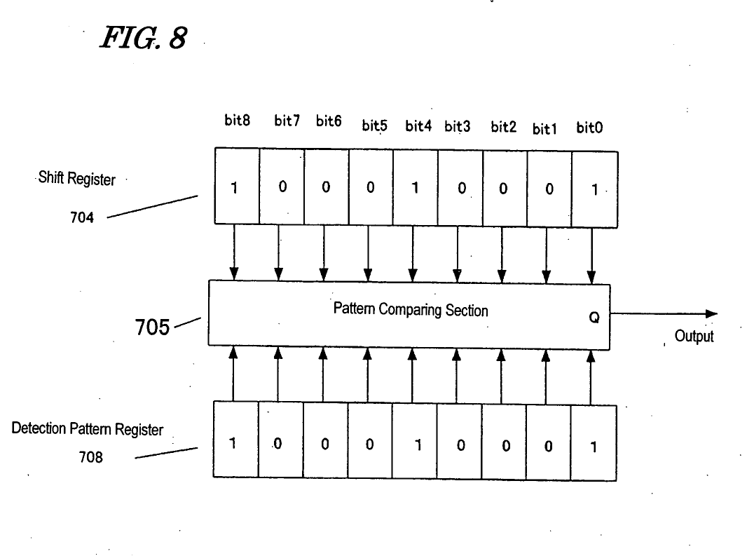

If the binary data stored in the shift register 704 is found matching with the binary data stored in the detection pattern register 708, then the count of the following counter 706 is incremented. FIG. 8 shows exemplary sets of information to be compared by the pattern comparing section 705. A VFO portion may be made up of pits each having a length of 4 T, for example. A pit with a length of 4 T is normally followed by a space with a length of 4 T. In that case, the information represented by the pits in the VFO portion is equivalent to binary data “100010001”. As shown in FIG. 8, this pattern is stored in the detection pattern register 708.

On the other hand, if information consisting of 4 T marks and 4 T spaces is included in the digitized read signal, then information “100010001” is stored in the shift register 704 at a certain point in time. Then, the pattern comparing section 705 obtains an exclusive logical sum on a bit-by-bit basis, thereby comparing the two sets of information with each other. If the two sets of information are found matching, then the pattern comparing section 705 outputs a signal showing the matching, which is counted by the counter 706. In this manner, the information representing the VFO portion can be detected completely. Furthermore, to determine whether or not multiple VFO portions, consisting of pits, are continuous with each other, a predetermined number of times of detection is set for a number-of-times-of-detection setting register 707 that defines how many times a certain pattern should be detected consecutively. And a comparator 709 compares the count of the counter 706 that has counted the outputs of the pattern comparing section 705 with the number of times that pattern has been detected consecutively. When the number of times the same pattern has been detected consecutively exceeds the predetermined value, the comparator 709 decides that the VFO section has been detected. As shown in FIG. 6, the control switching section 20 is operated in accordance with the output of this comparator 709, thereby turning the switch 17 OFF. In this manner, the frequency control section 16 is instructed to stop controlling the clock generator section 12. However, the clock generator section 12 is continuously subjected to phase control by the phase control section. As a result, the digitized read signal is synchronized with the clock signal through the phase control only.

Thereafter, the sync clock signal is generated only by the phase control. That is to say, as long as the address information included in the read signal can be obtained properly, the sync clock signal is generated with only the phase control continued and with the frequency control suspended.

However, when the frequency of the sync clock signal, generated only by the phase control, has shifted from that of the read signal so much that the address information cannot be properly acquired from the read signal anymore, the control switching section 21 turns the switch 17 ON. Then, a sync clock signal in phase with the digitized read signal can be generated through both frequency control and phase control.

And when the address information can be properly acquired from the read signal, the information about the VFO portion is detected by the information detecting section 18 again and the frequency control is stopped based on the detection result.

A procedure like this may be implemented as a combination of hardware components such as circuits made up of electronic parts or carried out by a microcomputer as the control switching section 21 or any other host computer. If this procedure is performed by a microcomputer or a host computer, then a computer-readable program (i.e., firmware) that is defined so as to carry out the procedure described above is stored in an information storage medium such as an EEPROM or a RAM.

As described above, according to this preferred embodiment, information about a VFO portion provided for a header area of an optical disc is detected. Accordingly, there is no concern about erroneously detecting a scratch on the optical disc, for example, as the beginning of the VFO portion, and therefore, just the VFO portion can be detected as intended. Consequently, the information about the VFO portion can be detected properly without performing any frequency control. Thus, the phase control is not affected by the frequency control and the read signal can maintain good quality.

In the preferred embodiment described above, the pattern comparing section 705 compares the entire information stored in the shift register 704 with that stored in the detection pattern register 708 on a bit-by-bit basis, thereby determining whether or not these two sets of information completely match with each other. In this manner, the information written in the VFO portion is identified from the read signal. However, not every bit has to be compared. For example, the pattern detecting section 705 shown in FIG. 8 may determine whether or not just bit 0, bit 4 and bit 8 of the information stored in the shift register 704 match with the counterparts of the information stored in the detection pattern register 708 and does not have to compare the other data (i.e., bits 1 through 3 and bits 5 through 7). The period of a signal representing a scratch on the optical disc is unlikely to match with that of the information represented by the pits in the VFO portion. Also, such matching is even less likely to occur twice or more consecutively. That is to say, the information detecting section 18 may detect information of which the period matches with that of the information represented by the VFO portion of the header area of the optical disc. Even so, there is very little concern about detecting a scratch done on the optical disc, for example, as the beginning of a VFO portion erroneously, and therefore, the VFO section can be detected almost just as intended.

Embodiment 2

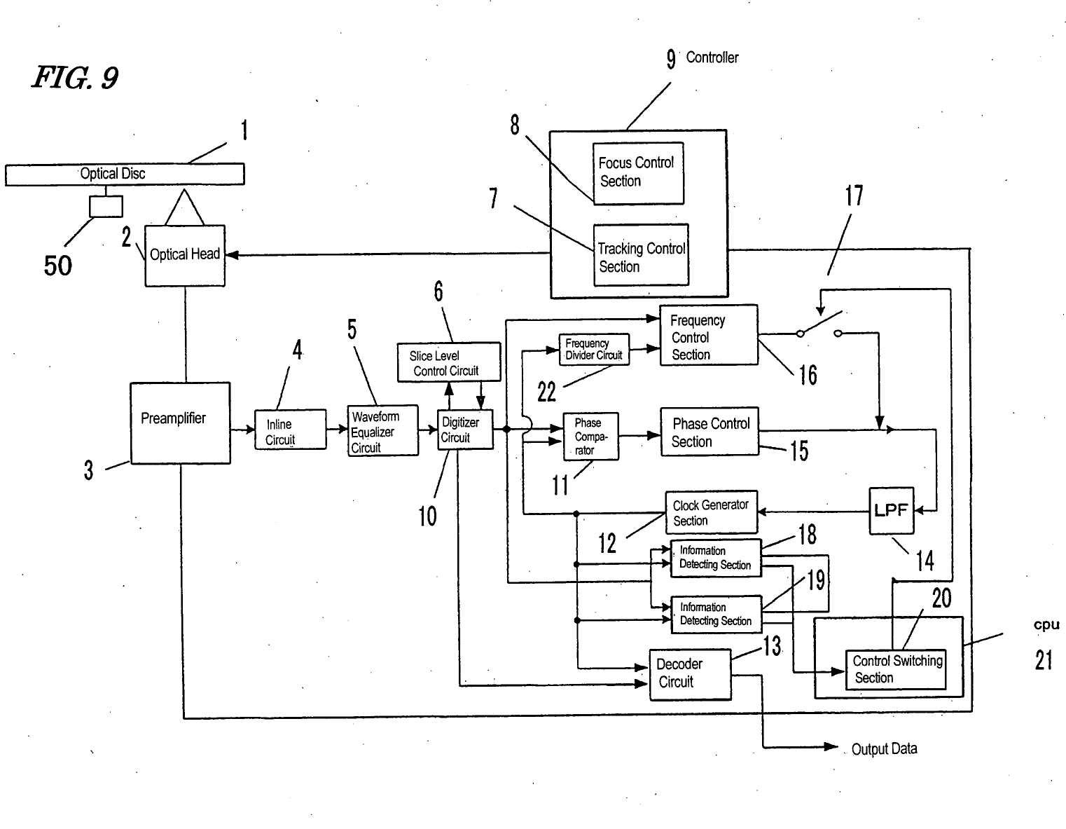

FIG. 9 is a block diagram showing an optical disc drive according to a second preferred embodiment of the present invention. Unlike the first preferred embodiment, the optical disc drive shown in FIG. 9 includes the first information detecting section 18 and a second information detecting section 19. In the description of the second preferred embodiment, any component having the same function as the counterpart of the first preferred embodiment described above is identified by the same reference numeral as that used for the first preferred embodiment.

The first information detecting section 18 has the same configuration as the counterpart of the first preferred embodiment. The second information detecting section 19 detects information, which changes in a period of the same length as the information represented by pits that are twice as long as the pits provided as the VFO portion of the header area of the optical disc, from the digitized read signal. And if the first information detecting section 18 has detected information representing the VFO from the digitized read signal or if the second information detecting section 19 has detected the information, which changes in a period of the same length as the information represented by pits that are twice as long as the pits provided as the VFO portion, then the control switching section 21 turns the switch 17 OFF such that only the phase control is continued. Hereinafter, the second information detecting section 19 will be described in detail.

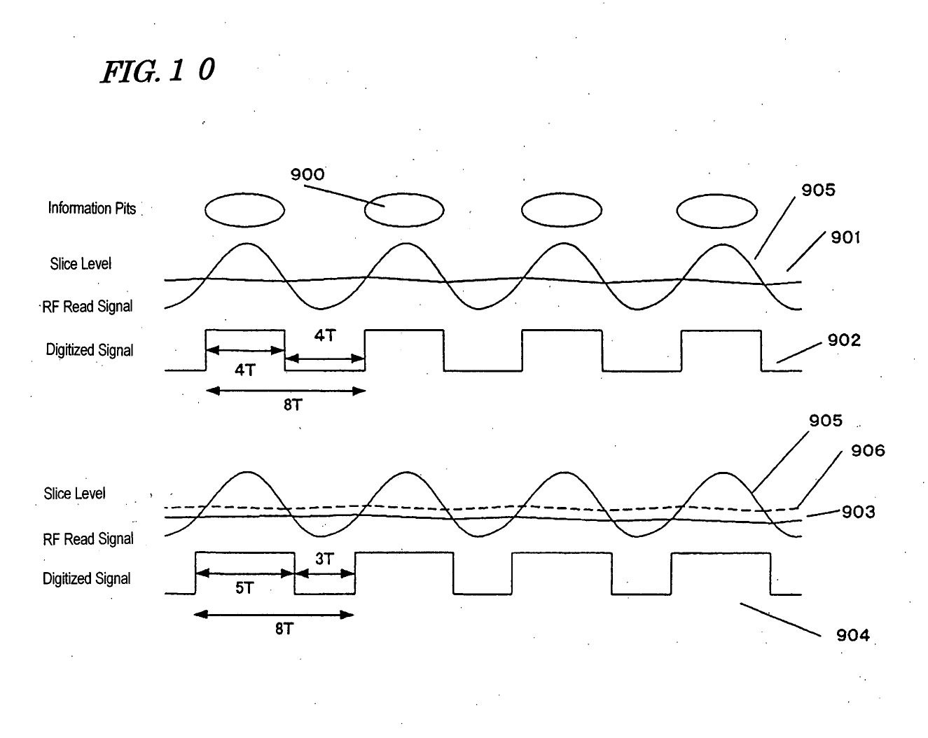

FIG. 10 schematically shows a digitized read signal to be generated from an RF read signal representing the pits on the VFO portion. If each of those pits 900 provided as the VFO portion has a length of 4 T, for example, then the RF read signal 905 to be generated from the pit 900 and input to the digitizer circuit 10 has a waveform such as that shown in FIG. 10. As shown in the upper portion of FIG. 10, if this RF read signal 905 is sliced at an appropriate level as indicated by the slice level 901 and digitized, then the resultant digitized read signal 902 will have a pulsed waveform consisting of marks and spaces with a length of exactly 4 T.

However, as shown in the lower portion of FIG. 10, if the slice level has shifted from the original level as indicated by the dashed line 906 toward the level indicated by the solid line 903 due to a variation in the DC level of the RF read signal, for example, then the leading edges shift forward and the trailing edges shift backward. Accordingly, the resultant digitized read signal 904 will have a waveform consisting of 5 T marks and 3 T spaces, for example. In such a state, the digitized read signal 904 cannot be detected as a repetitive pattern of 4 T marks and 4 T spaces.

Nevertheless, if the repetitive pattern of 4 T marks and 4 T spaces is recognized as 8 T pulses, then even the digitized read signal 904, consisting of 5 T marks and 3 T spaces, can be detected as 8 T pulses, too. That is to say, not by detecting the information represented by the pits provided as the VFO portion but by detecting the information, which changes in a period of the same length as the information represented by pits or marks that are twice as long as the pits or marks provided as the VFO portion, from the digitized read signal 904, the VFO portion can be detected just as intended even if the slice level has changed.

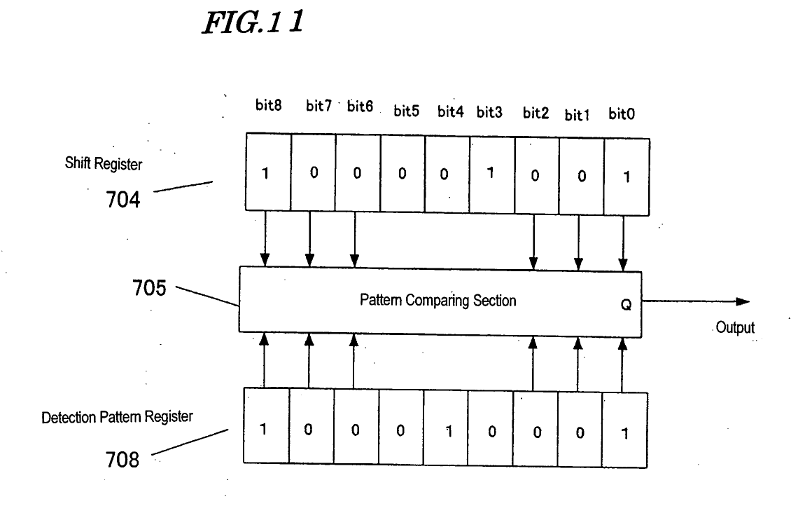

FIG. 11 schematically shows how the pattern comparing section 705 of the second information detecting section 19 obtains an exclusive logical sum. Information about the VFO portion included in the read signal is stored as binary data in the shift register 704. As described above, if a digitized read signal consisting of 5 T marks and 3 T spaces is obtained, then bit 0, bit 3 and bit 8 of the binary data will be “1”. On the other hand, information to be obtained when the information in the VFO portion is digitized properly is stored in the detection pattern register 708. More specifically, bit 0, bit 4 and bit 8 are “1”. The pattern comparing section 705 compares the two sets of information with each other for bits 0 through 2 and bits 6 through 8, but makes no comparison for the data stored at bits 3 through 5.

In this manner, the data stored at bits 3 through 5 are not compared. Accordingly, even if the two sets of information stored in the shift register 704 and detection pattern register 708 are different from each other at bit's 3 and 4, these two sets of information can still be regarded as being identical with each other. In that case, the digitized read signals 902 and 904 have the same frequency (or period) as shown in FIG. 10. That is to say, the clock signal, of which the frequency is equal to that of the digitized read signal 902, should have the same frequency as the digitized read signal 904, too. Thus, it is appropriate to decide that the second information detecting section 19 should have detected the information in the VFO portion through these computations and that the control switching section 21 should stop its frequency control. Consequently, by processing the read signal only by the phase control, the disturbance by the frequency control section 16 can be eliminated and the read signal can maintain good quality.

If the address information becomes no longer detectable after the frequency control has been stopped, the same procedure may be repeated again as described above for the first preferred embodiment.

A procedure like this may be implemented as a combination of hardware components such as circuits made up of electronic parts or carried out by a microcomputer as the control switching section 21 or any other host computer. If this procedure is performed by a microcomputer or a host computer, then a computer-readable program (i.e., firmware) that is defined so as to carry out the procedure described above is stored in an information storage medium such as an EEPROM or a RAM.

It should be noted that even if the slice level for obtaining the digitized read signal has shifted, the repetitive period of pits or marks does not change as already described with reference to FIG. 10. Accordingly, the second information detecting section may detect the information that changes in a period that is an integral number of times as long as one period of the pits or marks of the VFO portion.

Embodiment 3

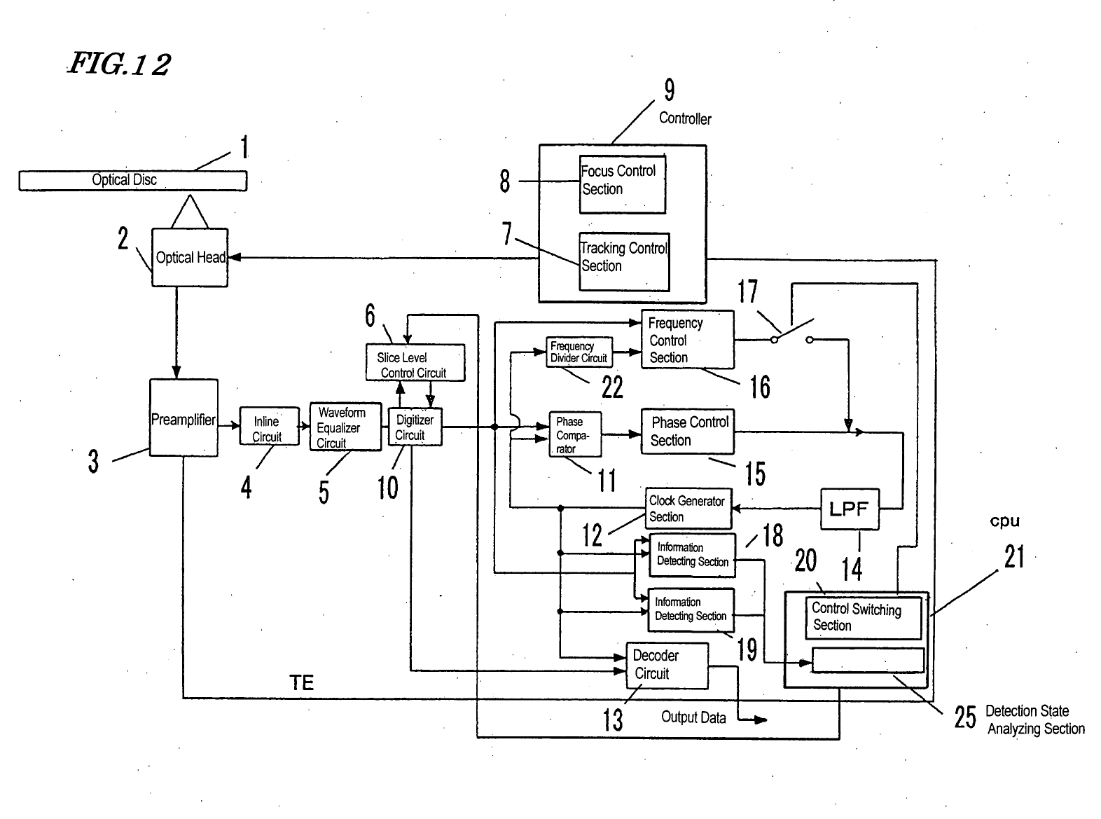

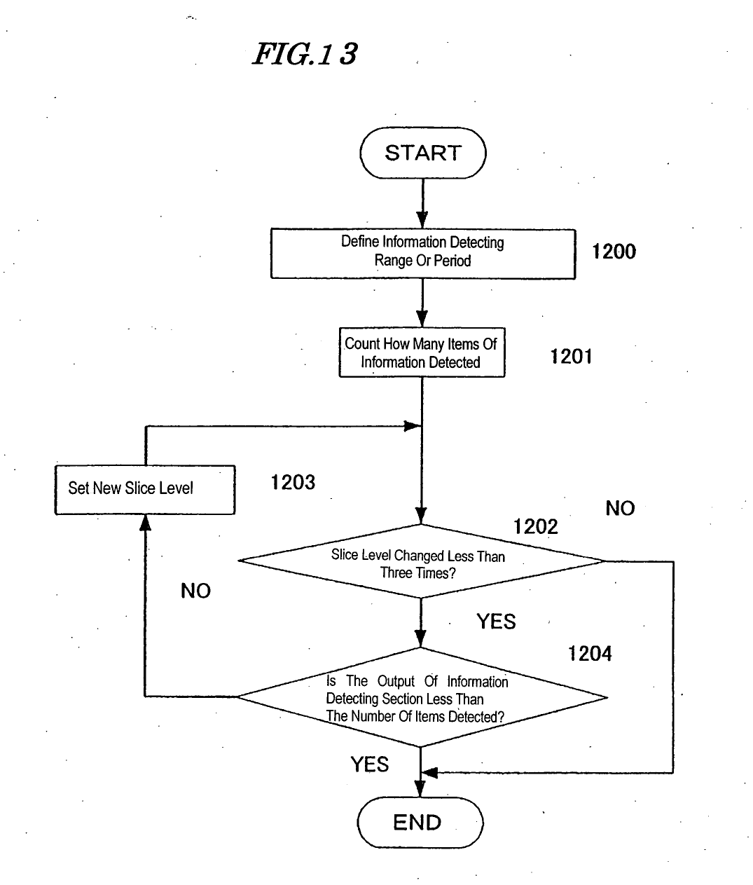

FIG. 12 is a block diagram showing an optical disc drive according to a third preferred embodiment of the present invention. Unlike the second preferred embodiment, the optical disc drive shown in FIG. 12 includes an information detection state analyzing section 25 for analyzing the detection state of the information detecting section and a slice level control circuit 6 and corrects the slice level for digitizing the read signal in accordance with the decision made by the information detection state analyzing section 25. In the description of the third preferred embodiment, any component having the same function as the counterpart of the second preferred embodiment described above is identified by the same reference numeral as that used for the second preferred embodiment.

The structures and functions of the first and second information detecting sections 18 and 19 are just as already described for the second preferred embodiment. In this preferred embodiment, however, the outputs of the first and second information detecting sections 18 and 19 are supplied to the information detection state analyzer 25. The optical disc drive to be described below includes both the first and second information detecting sections 18 and 19. However, the optical disc drive may include just one of these two detecting sections.

As already described with reference to FIG. 10, if the slice level for digitizing the read signal is inappropriate, then the information in the VFO portion of the optical disc cannot be read accurately. In such a situation, the first and second information detecting sections 18 and 19 might be unable to read the VFO portion in the read signal.

Thus, in this preferred embodiment, the information detection state analyzing section 25 corrects the slice level according to the number of items of information that could be detected by the first information detecting section 18 and/or second information detecting section 19. Hereinafter, the information detection state analyzing section 25 will be described in detail.

FIG. 13 shows the procedure of a correcting operation to be done by the information detection state analyzing section 25 to correct the slice level. First, in Step 1200, to analyze the current reading state of the optical disc drive, an information detecting range or an information detecting period is defined in accordance with the address information on the optical disc 1.

Next, in Step 1201, it is counted how many items of VFO information the first and/or second information detecting section(s) 18 and/or 19 have/has detected within the prescribed range or period. The number of ranges to be detected and recognized is defined in Step 1201 to determine whether or not that information could be detected.

Subsequently, in Step 1202, the number of times the slice level has been changed is compared with a predetermined reference value. The reference value may be set to three, for example. In that case, if the slice level has been changed more than three times, then the correcting operation is ended. By performing this step 1202, it is possible to prevent the correcting operation time from increasing excessively. A memory or any other storage having stored thereon the number of times the slice level has ever been changed is reset every time the correcting procedure shown in FIG. 13 is finished.

Thereafter, in the first and/or second information detecting section(s) 18 and/or 19, the comparator 709 compares the number of times the pattern representing the VFO information has been detected with a predetermined reference value stored in a number-of-times-of-detection setting register 707. In Step 1204, the information detection state analyzing section 25 receives the result of the comparison between the number of times of detection and the predetermined reference value from the first information detecting section 18 and/or the second information detecting section 19.

If the number of times of detection is smaller than the reference value, then the procedure advances to Step 1203, in which the information detection state analyzing section 25 outputs a signal to the slice level control circuit 6 to set a new slice level and memorizes the number of times the slice level has been changed. Thereafter, Steps 1202 and 1204 are repeatedly performed on the digitized signal obtained by using the updated slice level. The new slice level may be either directly output by the information detection state analyzing section 25 or generated by the slice level control circuit 6 in response to the signal supplied from the information detection state analyzing section 25.

On the other hand, on receiving in Step 1204 a signal indicating that the number of times of detection exceeds the reference value from the first information detecting section 18 and/or the second information detecting section 19, the information detection state analyzing section 25 finishes the correcting operation and outputs a signal, indicating that a single VFO signal has been detected, to the control switching section 20. As a result, the control switching section 20 turns the switch 17 OFF, thereby stopping the frequency control.

If the address information becomes no longer detectable after the frequency control has been stopped, the same procedure may be repeated again as described above for the first preferred embodiment.

The slice level to be set in Step 1203 may be either determined by the signal(s) received from the first information detecting section 18 and/or second information detecting section 19 in Step 1204 or defined in advance irrespective of the signal(s) received from the first and/or second information detecting section(s) 18 and/or 19.

A procedure like this may be implemented as a combination of hardware components such as circuits made up of electronic parts or carried out by a microcomputer as the control switching section 21 or any other host computer. If this procedure is performed by a microcomputer or a host computer, then a computer-readable program (i.e., firmware) that is defined so as to carry out the procedure described above is stored in an information storage medium such as an EEPROM or a RAM.

The information detection state analyzing section 25 may be implemented as a logic circuit, for example. Also, the slice level control circuit 6 may have the same configuration as the slice level generator circuit 23 and may be designed so as to output a predetermined voltage in response to the signal supplied from the information detection state analyzing section 25.

As described above, according to this preferred embodiment, the slice level is adjusted so as to detect at least a predetermined number of VFO information items. Accordingly, the information representing the VFO portion can be detected, and the frequency control can be stopped, with more certainty. Thus, an even more reliable read signal can be obtained by performing the phase control only.

Embodiment 4

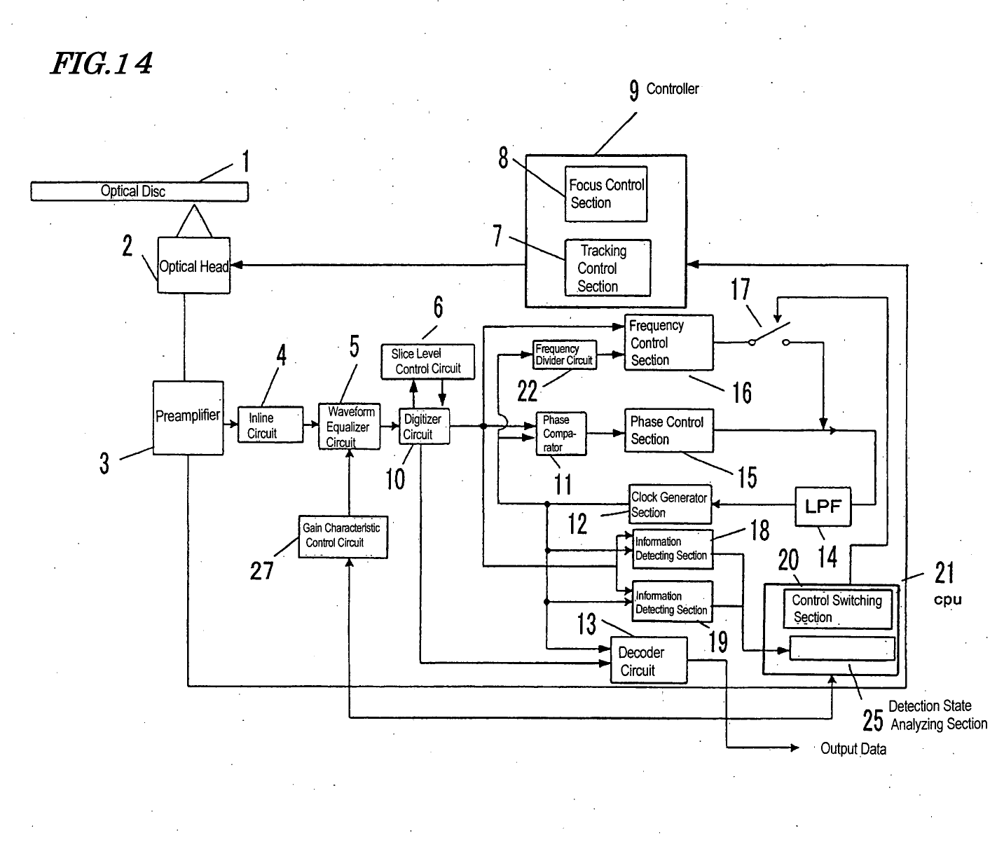

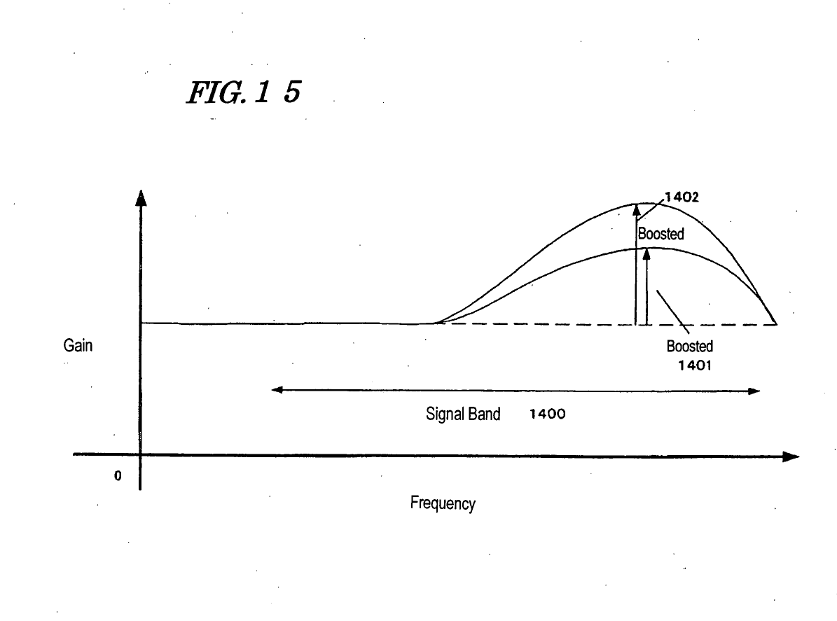

FIG. 14 is a block diagram showing an optical disc drive according to a fourth preferred embodiment of the present invention. Unlike the third preferred embodiment, the optical disc drive shown in FIG. 14 includes an information detection state analyzing section 26 and a gain characteristic control circuit 27. The information detection state analyzing section 25 of the third preferred embodiment changes the slice level according to the detection result. On the other hand, the information detection state analyzing section 26 of the fourth preferred embodiment changes the gain characteristic for getting the read signal amplified by a waveform equalizer circuit according to the detection result.

As already described with reference to FIG. 10, if the slice level for digitizing the read signal is inappropriate, then a read signal accurately reflecting the bit width of the VFO section of the optical disc cannot be obtained. In such a situation, the first and second information detecting sections 18 and 19 might be unable to identify or detect the VFO portion in the digitized read signal. Thus, in this preferred embodiment, the amplitude of the RF read signal is changed so as to compensate for the variation in the slice level, thereby reducing the variation in the slice level and improving the detection performance of the VFO portion.

FIG. 15 is a graph showing the gain characteristics of a waveform equalizer circuit 5, i.e., how much gain should be added with respect to the frequency of an amplifier circuit for amplifying the RF read signal output from the inline circuit 4. The amplitude of the RF read signal obtained from the optical disc 1 decreases in a high frequency range due to intersymbol interference, for example. For that reason, in a high frequency range of the signal band 1400 of the RF read signal, the gain is increased (or boosted), thereby compensating for the decrease in amplitude. The graph shown in FIG. 15 includes a boosted gain characteristic 1400 and another boosted gain characteristic 1402.

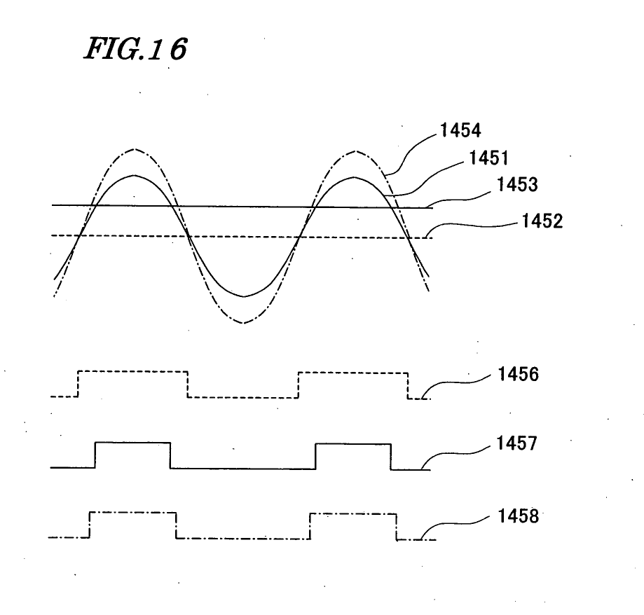

As shown in FIG. 16, if the RF read signal 1451 is digitized by reference to a slice level 1452, which is a predetermined proper level, then a digitized read signal 1456 can be obtained. However, if the digitizing level has varied so much that the RF read signal 1451 is digitized by reference to another slice level 1453, then leading edges shift backward and trailing edges shift forward. Thus, the pattern of the resultant digitized read signal 1457 becomes different from the intended pattern.

In this case, if the amplifying characteristic of the waveform equalizer circuit 5 is changed so as to increase the amplitude of the RF read signal, then an RF read signal 1454 can be obtained. And if the RF read signal 1454 is digitized with respect to the slice level 1453, a digitized read signal 1458 can be obtained. As is clear from FIG. 16, the shifts of the leading and trailing edges decrease. That is to say, even if the slice level has varied, the unwanted effects caused by the variation in slice level can be reduced, and a substantially intended digitized read signal can be obtained, by changing the amplifying characteristic of the waveform equalizer circuit 5.

An inappropriate slice level means that the first information detecting section 18 and/or the second information detecting section 19 cannot detect information about the VFO portion accurately. Thus, the information detection state analyzing section 26 corrects the gain characteristic based on the number of single signals that could be detected by the first information detecting section 18 and/or second information detecting section 19. Hereinafter, the information detection state analyzing section 26 will be described in detail.

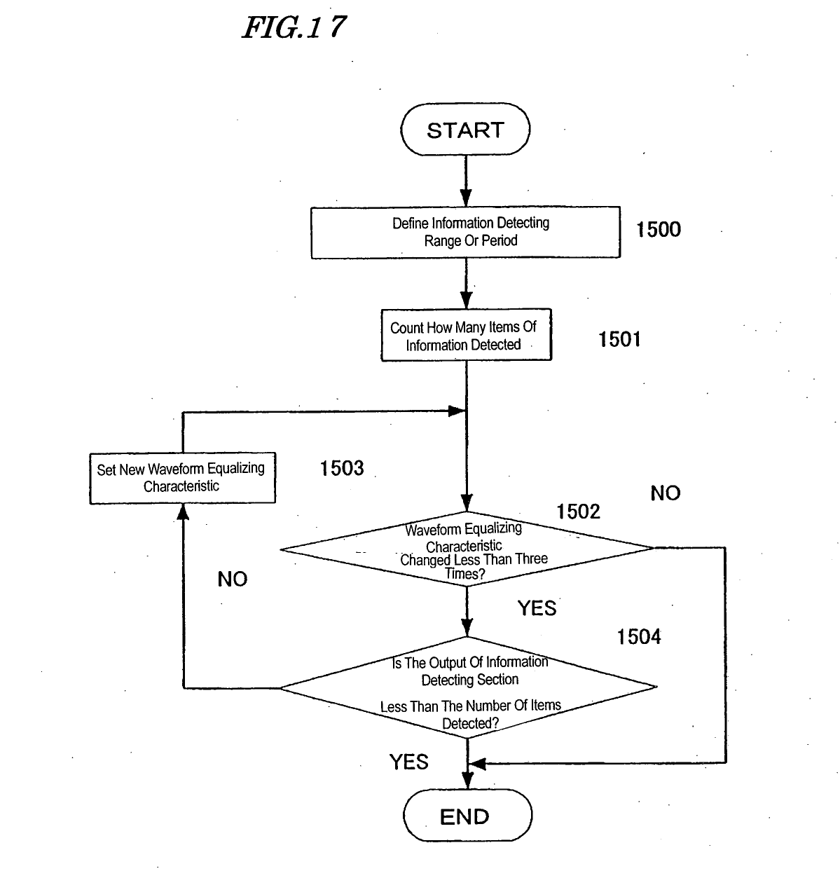

FIG. 17 shows the procedure of a correcting operation to be done by the information detection state analyzing section 26 to correct the gain characteristic. First, in Step 1500, to analyze the current reading state of the optical disc drive, an information detecting range or an information detecting period is defined in accordance with the address information on the optical disc 1.

Next, in Step 1501, it is counted how many items of VFO information the first and/or second information detecting section(s) 18 and/or 19 have/has detected within the prescribed range or period. The number of ranges to be detected and recognized is defined in Step 1501 to determine whether or not that information could be detected.

Subsequently, in Step 1502, the number of times the gain characteristic has been changed is compared with a predetermined reference value. The reference value may be set to three, for example. In that case, if the gain characteristic has been changed more than three times, then the correcting operation is ended. By performing this step 1502, it is possible to prevent the correcting operation time from increasing excessively. A memory or any other storage having stored thereon the number of times the gain characteristic has ever been changed is reset every time the correcting procedure shown in FIG. 17 is finished.

Thereafter, in the first and/or second information detecting section(s) 18 and/or 19, the comparator 709 compares the number of times the pattern representing the VFO information has been detected with a predetermined reference value stored in a number-of-times-of-detection setting register 707. In Step 1504, the information detection state analyzing section 25 receives the result of the comparison between the number of times of detection and the predetermined reference value from the first information detecting section 18 and/or the second information detecting section 19.

If the number of times of detection is smaller than the reference value, then the procedure advances to Step 1503, in which the information detection state analyzing section 25 outputs a signal to the gain characteristic control circuit 27 to set a new gain characteristic. In accordance with the signal supplied from the information detection state analyzing section 26, the gain characteristic control circuit 27 produces a new gain characteristic. Then, the waveform equalizer circuit 5 amplifies the RF read signal in accordance with the updated gain characteristic. The amplified RF read signal is input to the digitizer circuit 10, thereby generating the digitized read signal. In this case, the RF read signal has been amplified in accordance with a different gain characteristic. Accordingly, even if the slice level has not changed, the resultant digitized signal will have a different waveform.

Thereafter, Steps 1502 and 1504 are repeatedly performed on the digitized read signal obtained by using the updated gain characteristic.

On the other hand, on receiving in Step 1504 a signal indicating that the number of times of detection exceeds the reference value from the first information detecting section 18 and/or the second information detecting section 19, the information detection state analyzing section 26 finishes the correcting operation and outputs a signal, indicating that the VFO information has been detected, to the control switching section 20. As a result, the control switching section 20 turns the switch 17 OFF, thereby stopping the frequency control.

If the address information becomes no longer detectible after the frequency control has been stopped, the same procedure may be repeated again as described above for the first preferred embodiment.

The gain characteristic to be defined in Step 1503 may be either determined by the signal(s) received from the first information detecting section 18 and/or second information detecting section 19 in Step 1504 or defined in advance irrespective of the signal(s) received from the first and/or second information detecting section(s) 18 and/or 19.

A procedure like this may be implemented as a combination of hardware components such as circuits made up of electronic parts or carried out by a microcomputer as the control switching section 21 or any other host computer. If this procedure is performed by a microcomputer or a host computer, then a computer-readable program (i.e., firmware) that is defined so as to carry out the procedure described above is stored in an information storage medium such as an EEPROM or a RAM.

The information detection state analyzing section 26 may be implemented as a logic circuit, for example. In FIG. 14, the gain characteristic control circuit 27 is shown as a block independent of the waveform equalizer circuit 5. Alternatively, the waveform equalizer circuit 5 may also be designed so as to control multiple gain characteristics and to include the gain characteristic control circuit 27 therein. As another alternative, the gain characteristic control circuit 27 may also be made up of passive components such as amplifiers, coils, capacitors and resistors to be added to the amplifier circuit in the waveform equalizer circuit 5.

As described above, according to this preferred embodiment, the gain characteristic of the waveform equalizer circuit is adjusted so as to detect at least a predetermined number of VFO information items. Accordingly, the information representing the VFO portion can be detected, and the frequency control can be stopped, with more certainty. Thus, an even more reliable read signal can be obtained by performing the phase control only.

In the first through fourth preferred embodiments described above, an optical disc, on which the VFO portions are alternately offset with respect to the data tracks, is used as an example. However, the present invention is also applicable for use in an optical disc drive for reading and/or writing data from/on an optical disc with any other structure. For example, the present invention can be used effectively even in an optical disc drive for reading and/or writing data from/on an optical disc including VFO portions that are aligned with data tracks (such as a PD disc).

### INDUSTRIAL APPLICABILITY

According to the present invention, information about a VFO portion provided for the header area of an optical disc is detected. Thus, there is no concern about erroneously detecting a variation in the intensity of a read signal, caused by either a scratch on the optical disc or inconstant tracking control, as the beginning of the VFO portion, and just the VFO portion can be detected as intended. Also, even if the DC level of the RF read signal has varied or if any offset has been produced in the slice level, the information representing the VFO portion can still be detected either by detecting information, which changes in a period of the same length as the information represented by marks or pits that are twice as long as the pits in the VFO portion, or by changing the slice level or gain characteristic. Thus, it is possible to accurately detect the VFO information without performing any frequency control. As a result, an optical disc drive ensuring a read signal of quality and a control method thereof can be provided.

1. An optical disc drive for reading and/or writing data from/on an optical disc with a plurality of sectors, each said sector including a header area, in which at least two identical marks or pits are arranged so as to have a predetermined length apiece, and a data area to store user information thereon, the optical disc drive comprising:
an optical head, which emits light toward the optical disc and receives the light reflected from the optical disc, thereby outputting a signal;
read means for generating an RF read signal from the output signal of the optical head;
digitizing means for generating a digitized read signal from the RF read signal;
clock generating means for generating a clock signal;
a phase control section for controlling the clock generating means such that the phase of channel clock pulses of the digitized read signal matches with that of the clock signal;
a frequency control section for controlling the clock generating means such that the frequency of the channel clock pulses of the digitized read signal matches with that of the clock signal;
first information detecting means for detecting information represented by the marks or pits from the digitized read signal; and
control switching means for instructing the frequency control section to stop controlling the clock generating means based on detection results obtained by the first information detecting means.

2. The optical disc drive of claim 1, further comprising second information detecting means for detecting information, which changes in a period of the same length as the information represented by marks or pits that are twice as long as the predetermined length, from the digital read signal,
wherein the control switching means instructs the frequency control section to stop controlling the clock generating means based on detection results obtained by either the first information detecting means or the second information detecting means.

3. The optical disc drive of claim 1, further comprising third information detecting means for detecting information, which changes in a period that is an integral number of times as long as one period of the marks or the pits, from the digitized read signal,
wherein the control switching means instructs the frequency control section to stop controlling the clock generating means based on detection results obtained by either the first information detecting means or the second information detecting means.

4. The optical disc drive of one of claims 1 to 3 claim 1, wherein the information is binary data.

5. The optical disc drive of claim 4, wherein the marks or the pits make up a VFO section to be provided for the header area.

6. The optical disc drive of one of claims 1 to 5 claim 1, further comprising slice level control means for controlling a slice level at which the digitizing means generates the digitized read signal from the RF read signal,
wherein if the first, second or third information detecting means has failed to detect the information in a predetermined number or more, then the slice level is changed, but
wherein if the first, second or third information detecting means has successfully detected the information in at least the predetermined number, then the control switching means instructs the frequency control section not to control the clock generating means anymore.

7. The optical disc drive of one of claims 1 to 5 claim 1, further comprising:
waveform equalizing means for amplifying the RF read signal with such a gain characteristic as increasing an amplification factor in a higher frequency range; and
gain characteristic control means for controlling the gain characteristic,
wherein if the first, second or third information detecting means has failed to detect the information in a predetermined number or more, then the gain characteristic is changed, but
wherein if the first, second or third information detecting means has successfully detected the information in at least the predetermined number, then the control switching means instructs the frequency control section not to control the clock generating means anymore.

8. A method for controlling an optical disc drive, which reads and/or writes data from/on an optical disc with a plurality of sectors, each said sector including a header area, in which at least two identical marks or pits are arranged so as to have a predetermined length apiece, and a data area to store user information thereon, the method comprising the steps of:
(A) generating a digitized read signal from light that has been emitted toward, and reflected from, the optical disc;
(B) generating a clock signal and controlling the phase and frequency of the clock signal such that the phase and frequency of the clock signal match with those of channel clock pulses of the digitized read signal; and
(C1) stopping controlling the frequency of the clock signal as soon as information represented by the marks or pits is detected from the digitized read signal.

9. The method of claim 8, further comprising the step (C2) of stopping controlling the frequency of the clock signal as soon as information, which changes in a period of the same length as the information represented by marks or pits that are twice as long as the predetermined length, is detected from the digitized read signal.

10. The method of claim 8, further comprising the step (C3) of stopping controlling the frequency of the clock signal as soon as information, represented by marks or pits of which the period is an integral number of times as long as one period of the marks or the pits, is detected from the digitized read signal.

11. The method of one of claims 7 to 10 claim 7, wherein the information is binary data.

12. The method of claim 11, wherein the marks or the pits make up a VFO section.

13. The method of one of claims 7 to 12 claim 7, wherein the step (A) includes the steps of:
(a1) generating an RF read signal from the reflected light; and
(a2) generating the digitized read signal from the RF read signal according to a predetermined slice level, and
wherein the method further includes the step (D1) of changing the slice level for use in the step (a3) if the information has not been detected in a predetermined number or more in the step (C1), (C2) or (C3), but stopping controlling the frequency of the clock signal if the first, second or third information detecting means has successfully detected the information in at least the predetermined number.

14. The method of claim 1, wherein the step (A) includes the steps of:
(a1) generating an RF read signal from the reflected light;
(a3) amplifying the RF read signal with such a gain characteristic as increasing an amplification factor in a higher frequency range; and
(a4) generating the digitized read signal from the amplified RF read signal according to a predetermined slice level, and
wherein the method further includes the step (D2) of changing the gain characteristic for use in the step (a3) if the information has not been detected in a predetermined number or more in the step (C1), (C2) or (C3), but stopping controlling the frequency of the clock signal if the first, second or third information detecting means has successfully detected the information in at least the predetermined number.

15. The method of claim 7, wherein if no address information is detectible from the digitized read signal anymore when control of the frequency of the clock signal is stopped in the step (C1), (C2), (C3), (D1) or (D2), then the step (B) and one of the steps (C1), (C2) and (C3) are performed.

16. A computer readable storage medium having stored thereon a program that is defined so as to make a computer execute the respective steps of the method of claim 7.
